(19) United States
(12) Patent Application Publication
(10) Pub. No.: US 2022/0164412 A1
(43) Pub. Date: May 26, 2022

(54) INFORMATION PROCESSING SYSTEM

(71) Applicant: Hitachi, Ltd., Tokyo (JP)

(72) Inventor: Takuya OKUYAMA, Tokyo (JP)

(21) Appl. No.: 17/160,437

(22) Filed: Jan. 28, 2021

(30) Foreign Application Priority Data
Nov. 25, 2020 (JP) 2020-195300

(51) Int. Cl. G06F 17/16

(52) U.S. Cl. CPC G06F 17/16

(57) ABSTRACT

A system including a variable memory that stores variables, a state transition calculation block that calculates the next state of the variable, a non-linear coefficient memory that stores the non-linear coefficient of the state transition calculation block, a linear coefficient memory that stores the linear coefficient of the state transition calculation block, and a temperature input line that receives the temperature signal of the state transition calculation block. The state transition calculation block includes an interaction calculation execution unit that calculates the next state of the variable based on the variable, the non-linear coefficient, the linear coefficient, and the temperature signal, and a descending direction calculation unit that calculates the next state of the variable based on the variable, the non-linear coefficient, and the linear coefficient. Then, a control signal that selects the operations of the interaction calculation execution unit and the descending direction calculation unit is provided.

### CROSS-REFERENCE TO RELATED APPLICATION

The present application claims priority from Japanese application JP 2020-195300, filed on Nov. 25, 2020, the contents of which is hereby incorporated by reference into this application.

### BACKGROUND OF THE INVENTION

### 1. Field of the Invention

The present invention relates to an information processing technique and a technique for executing an optimum solution search process.

### 2. Description of Related Art

JP-A-2016-51314 discloses “a semiconductor device including a plurality of units that each includes a first memory cell that stores a value representing one spin of the Ising model in three or more states, a second memory cell that stores an interaction coefficient indicating an interaction from another spin that interacts with one spin, and a logic circuit that determines the next state of one spin based on a value that represents the state of another spin and a function that has the interaction coefficient as a constant or variable”.

WO2019/216277 describes a method for realizing an optimum solution search by stochastically updating all spins at the same time while satisfying the theoretical background required by the Markov chain Monte Carlo method for an Ising model having an arbitrary coupling.

Many physical and social phenomena can be expressed by interaction models. An interaction model is defined by a plurality of nodes constituting the model, interactions between the nodes, and if necessary, coefficients that act on each node. In the fields of physics and social science, various models including the Ising model have been proposed, but all of them can be interpreted as a form of interaction model.

It is important to find the node state that minimizes or maximizes the index associated with this interaction model in solving social issues. For example, there are issues of detecting creeks in social networks and portfolio optimization in the financial field. In the fields of operations and research, these are roughly divided into unconstrained binary quadratic programming problems and mixed binary quadratic programming problems.

When solving the interaction model, the variables can be updated in parallel by solving the original problem represented by the fully connected graph (FIG. 3 described later) by replacing the original problem with a complete bipartite graph (FIG. 2 described later). At this time, if simulated annealing (hereinafter referred to as SA) described later is executed in the fully connected graph, the local solution can be reached with high probability. On the other hand, when a solution is obtained by replacing it with a complete bipartite graph and applying an algorithm utilizing the Markov chain Monte Carlo method (hereinafter referred to as MCMC), there is no clear evidence that a local solution has been reached in the fully connected graph model. If it is not a local solution in the model of the fully connected graph, a better solution can be obtained if there is means to transition to the local solution.

The present invention has been made in view of the above background and an object thereof is to provide a technique for obtaining a high-quality solution by searching for the optimum solution of a problem, including searching for the ground state of the Ising model.

### SUMMARY OF THE INVENTION

A preferred aspect of the present invention is a system including a variable memory that stores variables, a state transition calculation block that calculates the next state of the variable, a non-linear coefficient memory that stores a non-linear coefficient of the state transition calculation block, a linear coefficient memory that stores a linear coefficient of the state transition calculation block, and a temperature input line that receives a temperature signal of the state transition calculation block. In this system, the state transition calculation block includes an interaction calculation execution unit that calculates the next state of the variable based on the variable, the non-linear coefficient, the linear coefficient, and the temperature signal, and a descending direction calculation unit that calculates the next state of the variable based on the variable, the non-linear coefficient, and the linear coefficient. Then, a control signal line that receives a control signal that selects operations of the interaction calculation execution unit and the descending direction calculation unit is provided.

A more preferable aspect of the present invention is that the interaction calculation execution unit expresses the interaction model as a complete bipartite graph between the variables and updates the variables s in parallel, and the descending direction calculation unit calculates s′ in which the objective function H of the interaction model is H(s′)≤H(s) based on the variable s.

According to the present invention, a high-quality solution can be obtained in an optimization problem. Issues, configurations, and effects other than those described above will be clarified by the following description of embodiments for carrying out the invention.

### BRIEF DESCRIPTION OF THE DRAWINGS

FIG. 1 is a conceptual diagram showing a relationship between a variable array and an objective function value in an optimization problem;

FIG. 2 is a diagram for illustrating an embodiment;

FIG. 3 is a diagram for illustrating an embodiment;

FIG. 4 is a block diagram showing a schematic configuration of an information processing device;

FIG. 5A is a block diagram of an arithmetic circuit;

FIG. 5B is a block diagram of an interaction calculation execution unit;

FIG. 6 is a functional block diagram showing a main function of the information processing device;

FIG. 7 is a flowchart illustrating an optimum solution search process;

FIG. 8 is a detailed block diagram of the arithmetic circuit; and

FIG. 9 is a block diagram of a unit constituting the arithmetic circuit.

### DESCRIPTION OF EMBODIMENTS

Hereinafter, embodiments will be described in detail with reference to the drawings. In the following description, the same or similar configurations are denoted by common reference numerals and the duplicated descriptions may be omitted. Further, when there are a plurality of elements having the same or similar functions, the description may be made with the same reference numerals having different subscripts. If it is not necessary to distinguish between multiple elements, the subscripts may be omitted for the explanation.

Notations such as “first”, “second”, and “third” in the present specification and the like are attached to identify the components and do not necessarily limit the number, order, or contents thereof. In addition, numbers for identifying components are used for each context, and numbers used in one context do not always indicate the same configuration in other contexts. Further, it does not prevent the component identified by a certain number from having a function of the component identified by another number.

One embodiment described below is an arithmetic circuit including a variable memory that stores a value indicating the state of a variable in a mixed integer quadratic programming problem, a non-linear coefficient memory that stores the non-linear coefficient of a state transition calculation block corresponding to the variable memory, a linear coefficient memory that stores the linear coefficient of the state transition calculation block corresponding to the variable memory, a weight input line that receives the weight signal of the state transition calculation block, a temperature input line that receives the temperature signal of the state transition calculation block, a difference calculation block that calculates a difference using the weight signal of the state transition calculation block, the non-linear coefficient of the state transition calculation block, and the linear coefficient of the state transition calculation block, a sampling block that randomly samples from a probability distribution with interval constraints using the weight signal of the state transition calculation block, the temperature signal of the state transition calculation block, and the output value of the difference calculation block, and a next state calculation block that calculates the next state of the variable using the output value of the sampling block and the value read from the variable memory.

In general, an integer programming problem refers to an optimization problem that includes integer variables. Also, when variables that take integer values and variables that take real numbers are mixed, it is called a mixed integer programming problem. A mixed integer programming problem that is a quadratic programming problem is referred to as a mixed integer quadratic programming problem. In the present specification, a mixed integer quadratic programming problem in which variables that take binary values in particular and variables that take real values are mixed is referred to as a mixed binary quadratic programming problem. First, the significance of the mixed binary quadratic programming problem will be explained.

Depending on the optimization problem desired to solve, binary variables and continuous variables may be mixed. For example, in the problems in the financial field, the purchase ratio of financial products may be 0% or 10% to 100%. If the product is not purchased, it will be, of course, 0%, and if the product is purchased, it will be 10% or more of the minimum unit. At this time, using the binary variable x ∈ {−1, 1} and the continuous variable y ∈ [−1, 1], which indicate whether to purchase or not, the purchase ratio r can be expressed by:

r={(1+x)/2}×{0.1+0.9×(1+y)/2}

It is possible to express the continuous variable y discretely with a plurality of binary variables, but by making it possible to handle continuous variables, the number of variables is only one. Therefore, by allowing the computer system to handle continuous variables, the number of variables in the optimization problem can be reduced and the scale of the problem that can be handled by the computer resources can be increased. Moreover, when solving a certain problem, it can be expected that the calculation time is shortened because the number of variables is reduced.

On the other hand, it is possible to handle the problem only with continuous variables, but with continuous variables, values such as 0.3 are allowed even for variables for which only −1 or +1 is desired to be accepted as a value. In this case, if the constraint that “variable x is −1 or +1” is added to the objective function as, for example, a penalty function (x²−1)², it is possible to handle the variable x as a continuous variable but it will not be a quadratic expression. In addition, there is a problem that the objective function becomes complicated and it is difficult to find the optimum solution. Therefore, when creating a quadratic programming problem, there is an advantage of a configuration in which the domain of a predetermined variable is set to a binary value or a discrete value from the beginning so that it can be handled by a computer. Hereinafter, when referred to only as an optimization problem in the present specification, it means a mixed binary quadratic programming problem.

There are N variables of s₁, . . . , s_{N} for the optimization problem (here, meaning the mixed binary quadratic programming problem). The domain Dᵢ of each variable is either a binary value {−1, +1} or a continuous value [−1, +1]. Which one is decided for each problem. Then, the objective function H of the optimization problem is expressed by the following Equation 1. That is, the objective function H is represented by a quadratic expression of the variable s.

$$\begin{matrix}[ Equation 1 ] & \\ H ( s ) = - \frac{1}{2} {s}^{T} J s - {h}^{T} s & ( 1 )\end{matrix}$$

In Equation 1, the N-dimensional vector of s=[s₁, . . . , s_{N}], J is an N×N symmetric matrix and h is an N-dimensional vector. As described above, since the domain is different for each variable, the mixed binary quadratic programming problem can be expressed by the following Equation 2.

$$\begin{matrix}[ Equation 2 ] & \\ {min}_{{s}_{i} ∈ {D}_{i}} H ( s ) & ( 2 )\end{matrix}$$

Here, the sets of subscripts Λ_{b} and Λ_{c} are defined as in Equation 3.

$$\begin{matrix}[ Equation 3 ] & \\ \{ \begin{matrix}{Λ}_{b} = \{ i \vert {D}_{i} = \{ - 1 , 1 \} \} \\ {Λ}_{c} = \{ i \vert {D}_{i} = [ - 1 , 1 ] \}\end{matrix} & ( 3 )\end{matrix}$$

The set S_{mixed}={s|sᵢ ∈ Dᵢ} is defined. Using these notations, Equation 2 can also be expressed as Equation 4.

$$\begin{matrix}[ Equation 4 ] & \\ {min}_{s ∈ {S}_{mixed}} H ( s ) & ( 4 )\end{matrix}$$

After that, for all i ∈ Λ_{b}, the element of the i-th row and i-th column of the matrix J is set to 0. This is because this transformation does not change the optimum solution of Equation 2.

If Dᵢ={−1, +1} for all i, this optimization problem is a combinatorial optimization problem called the ground state search problem of the Ising model. In the present embodiment, in the optimization problem including the ground state search of the Ising model, the optimum solution or the approximate solution is searched by the algorithm utilizing the Markov chain Monte Carlo method (MCMC).

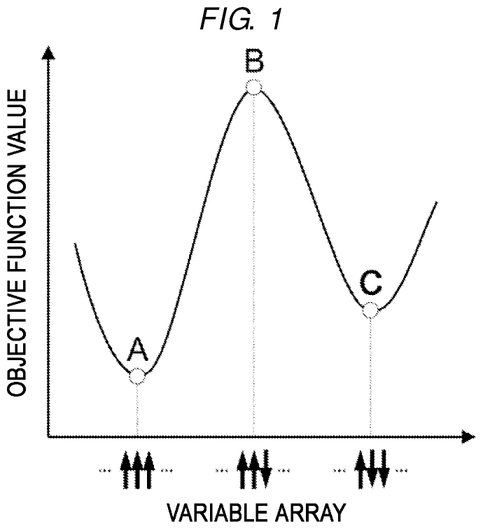

FIG. 1 is a conceptual diagram showing a landscape of objective function values for a variable array. The horizontal axis of the graph is the variable array s, and the vertical axis is the objective function H(s). MCMC repeats a stochastic transition from the current state s to a state s′ near the state s. The probability of transition from the state s to the state s′ is referred to as a transition probability P(s, s′). Examples of the transition probability P include the Metropolis method and the heat-bath algorithm.

The transition probability has a parameter called temperature, which indicates the ease of transition between states. When MCMC is performed while gradually decreasing the temperature from a large value, it asymptotically converges to the state where the objective function value is the lowest. Simulated annealing (SA) and momentum annealing (hereinafter referred to as MA) proposed in Okuyama, T., Sonobe, T., Kawarabayashi, K. I., & Yamaoka, M. (2019). Binary optimization by momentum annealing. Physical Review E, 100(1), 012111 are methods for finding the optimum solution or approximate solution of the minimization problem by utilizing the above.

In solving the minimization problem shown in Equation 4, solving the minimization problem of Equation 5 is considered instead. Here the set S_{relaxed}={s|sᵢ ∈ [−1, +1]}.

$$\begin{matrix}[ Equation 5 ] & \\ {min}_{s ∈ {S}_{relaxed}} H ( s ) & ( 5 )\end{matrix}$$

The optimum solution of Equation 5 is expressed as s*=[s₁*, . . . , s_{N}*]. Although the proof is omitted, s⁺=[s₁⁺, . . . , s_{N}⁺] obtained by the following Equation 6 is one of the optimum solutions of Equation 4. The goal of this embodiment is to search for the optimum solution of Equation 2, but it is possible to obtain the desired solution s⁺ even if the transformation of Equation 6 is obtained after solving the optimum solution s* of Equation 5. However, the function sgn is a function that returns +1 if the argument is 0 or more, and −1 otherwise.

$$\begin{matrix}[ Equation 6 ] & \\ {s}_{i}^{+} = \{ \begin{matrix}sgn ( {s}_{i}^{*} ) & ( i ∈ {Λ}_{b} ) \\ {s}_{i}^{*} & ( i ∈ {Λ}_{c} )\end{matrix} & ( 6 )\end{matrix}$$

Here, the N-dimensional vector v=[v₁, . . . , v_{N}] is introduced to define the function H′ shown in Equation 7.

[Equation 7]

H′(s, v)=H(s)+V(v) (7)

However, the function V(v) is as defined in Equation 8.

$$\begin{matrix}[ Equation 8 ] & \\ V ( v ) = \frac{1}{2} {v}^{T} ( J + 2 W ) v & ( 8 )\end{matrix}$$

The matrix W=diag (w₁, . . . , w_{N}) is an arbitrary diagonal matrix and vᵢ is a real number that moves [−1, +1]. Instead of the minimization problem shown in Equation 5, Equation 9 which is a minimization problem of H′(s, v) is introduced.

$$\begin{matrix}[ Equation 9 ] & \\ {min}_{s ∈ {[ - 1 , 1 ]}^{N}} H ( s ) + {min}_{v ∈ {[ - 1 , 1 ]}^{N}} V ( v ) & ( 9 )\end{matrix}$$

Two N-dimensional vectors x=s+v and y=s−v are defined. The objective function of the optimization problem that is originally desired to solve is only H, but by introducing a function called V here, it is possible to obtain a new function that can be updated in parallel by MCMC. Then, the function H′ can be rewritten as Equation 10.

$$\begin{matrix}[ Equation 10 ] & \\ {H}^{′} = \frac{1}{2} \{ - {x}^{T} Jy - {h}^{T} ( x + y ) + \frac{{( x - y )}^{T} W ( x - y )}{2} \} & ( 10 )\end{matrix}$$

That is, the minimization problem of Equation 5 can be rephrased as the minimization problem of Equation 11.

$$\begin{matrix}[ Equation 11 ] & \\ {min}_{\vert {x}_{i} \vert + \vert {y}_{i} \vert \leq 2} \{ G ( x , y ) := - {x}^{⊤} Jy - {h}^{⊤} ( x + y ) + \frac{{( x - y )}^{⊤} W ( x - y )}{2} \} & ( 11 )\end{matrix}$$

If the optimum solution of Equation 11 is expressed as x* and y*, the equation s*=(x*+y*)/2 is established. These arguments are established even if W is a zero matrix.

From the above, the optimum solution of the mixed binary quadratic programming problem represented by Equation 2 can be obtained from the solution of the constrained quadratic programming problem shown in Equation 11. MCMC is used to find this solution.

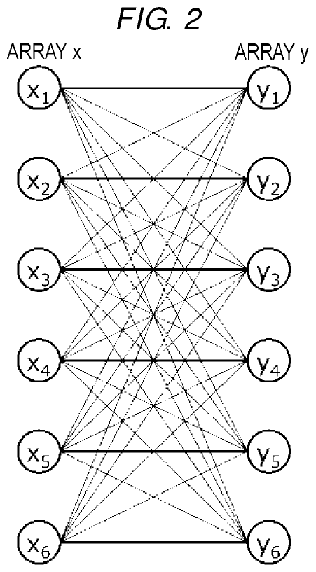

FIG. 2 is a graphical model showing the relationship between the variables of the function G in Equation 11. The relationship between the variables of the function G can be represented by a complete bipartite graph. The only variables that can be multiplied by the variable xᵢ in the function G are y₁, . . . , y_{N} and xᵢ. When MCMC stochastically updates a variable value, the value of the variable related to that variable is used. That is, y₁, . . . , y_{N}, and x₁ are obtained when updating the value of the variable x₁, and other variables (here, x₂, . . . , x_{N}) are not referred to. This also applies to updating the value of other variables, such as x₂. Therefore, if the value of the variable array y is constant, the theoretical requirement of MCMC is not violated even if each value of the array x is stochastically updated independently at the same time.

Similarly, the variables that can be multiplied by the variable yᵢ are only x₁, . . . , x_{N} and yᵢ. Therefore, under a constant value of the variable array x, each value of the array y can be stochastically updated independently at the same time.

From the above, by executing MCMC composed of the procedure of repeating “simultaneous update of x₁, . . . , x_{N}” and “simultaneous update of y₁, . . . , y_{N}”, it is possible to search for arrays x and y that minimize the function G while enjoying the advantage of speeding up by parallelization.

Note that in the argument of this embodiment, there are no constraints on the matrix J. For example, even when all the elements of the matrix J are non-zero, the above argument is established and thus, a parallel update is possible.

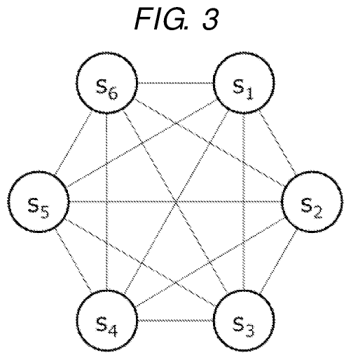

FIG. 3 is an example of a fully connected graph. On the other hand, when MCMC is applied directly to the minimization problem of Equation 2, which is the original problem, the relationship of the variable array s is represented by a fully connected graph as shown in FIG. 3, and thus, the probability for only one variable can be updated at a time and it is limited to sequential update.

From here, the procedure for the stochastic update for each variable will be described. Let xᵢ be the variable to be updated. When the values of the variables y₁, . . . , y_{N} are constant, the existence probability p(xᵢ) of the variable xᵢ in the Boltzmann distribution at the temperature T satisfies Equation 12.

$$\begin{matrix}[ Equation 12 ] & \\ p ( {x}_{i} ) ∝ {e}^{- \frac{{w}_{i}}{2 T} ( {( {x}_{i} - \frac{{A}_{i}}{{w}_{i}} )}^{2} - \frac{{A}_{i}^{2}}{{w}_{1}^{2}} )} & ( 12 )\end{matrix}$$

However, the variable Aᵢ is the value obtained by Equation 13.

$$\begin{matrix}[ Equation 13 ] & \\ {A}_{i} = {h}_{i} + {w}_{i} {y}_{i} + {\sum }_{j}^{ } {J}_{ij} {y}_{j} & ( 13 )\end{matrix}$$

In this example, since the variables xᵢ and yᵢ are set to the condition of |xᵢ|+|yᵢ|≤2, the range in which xᵢ can move is −(2−|yᵢ|) or more and (2−|yᵢ|) or less. The range of movement may be changed depending on the conditions. Therefore, based on the truncated normal distribution whose normal distribution has mean Aᵢ/wᵢ and variance T/wᵢ, and whose domain is −(2−|yᵢ|) or more and (2−|yᵢ|) or less, the variable xᵢ only needs to sample the next state of xᵢ. In this method, the next state is determined regardless of the current state of xᵢ. The same applies to yᵢ. In the present specification, when the variables of x and y are not distinguished, they may be expressed as s.

Random numbers that follow the standard normal distribution can be generated by the Box-Muller method. Since the domain is limited here, for example, the algorithm shown “Botev, Z. I. (2017). The normal law under linear restrictions: simulation and estimation via minimax tilting. Journal of the Royal Statistical Society: Series B (Statistical Methodology), 79(1), 125-148.” is preferably used.

The optimum solution search can be regarded as sampling from the equilibrium state at temperature 0. Therefore, in order to realize a high-quality solution search, it is preferable to converge to an equilibrium state in a short time. Various techniques have been proposed by MCMC in order to improve the convergence to the equilibrium state, and these techniques can also be utilized. For example, “Neal, R. M. (1998). Suppressing random walks in Markov chain Monte Carlo using ordered overrelaxation. In Learning in graphical models (pp. 205-228). Springer, Dordrecht.” suggests the over-relaxation method. As a candidate for the next state, not only one state but also K states are sampled from the Boltzmann distribution at temperature T. Then, in addition to the sampled K states, the total (K+1) states of the current state are rearranged and expressed as x_{c}⁰≤x_{c}^{r}=xᵢ≤x_{c}^{K}. That is, the current state is the (r+1)-th from the smallest of the (K+1) values. Then, x_{c}^{K+1-r} is adopted as the next state. In this method, the next state depends on the current state of xᵢ.

As described above, the minimization problem of Equation 5 can be solved. In addition, “H. Goto, K. Tatsumura and A. R. Dixon: “Combinatorial optimization by simulating adiabatic bifurcations in nonlinear hamiltonian systems”, Science Advances, 5, 4 (2019)” and “S. Matsubara, H. Tamura, M. Takatsu, D. Yoo, B. Vatankhahghadim, H. Yamasaki, T. Miyazawa, S. Tsukamoto, Y. Watanabe, K. Takemoto, et al.: “Ising-model optimizer with parallel-trial bitsieve engine”, Conference on Complex, Intelligent, and Software Intensive Systems Springer, pp. 432-438 (2017)” have been reported as techniques for solving the ground state search problem of the Ising model. In these techniques, instead of searching for the ground state of the model of FIG. 3, the ground state of the model of FIG. 2 is searched. However, just because FIG. 2 reaches the local solution, there is no clear reason for reaching the local solution of the original problem shown in FIG. 3. If it is not a local solution, a better solution can be obtained by moving it to a lower energy state. A method for achieving this will be described below.

Vector γ and vector d are N-dimensional vectors. Further, λ is the maximum eigenvalue of −J. Here, it is assumed that each component d₁, . . . , d_{N} of the vector d satisfies the following Equation 14.

$$\begin{matrix}[ Equation 14 ] & \\ 0 \leq {γ}_{i} {d}_{i} ⋀ \vert {d}_{i} \vert \leq \{ \begin{matrix}\frac{2 \vert {γ}_{i} \vert}{λ} & ( λ > 0 ) \\ ∞ & ( λ \leq 0 )\end{matrix} & ( 14 )\end{matrix}$$

At this time, the following Inequality 15 holds.

$$\begin{matrix}[ Inequality 15 ] & \\ - \frac{1}{2} {d}^{⊤} Jd - {γ}^{⊤} d \leq 0 & ( 15 )\end{matrix}$$

Also, given the positive numbers λ, γ, and ξ, the following Equation 16 is clearly established.

$$\begin{matrix}[ Equation 16 ] & \\ arg {min}_{z ∈ ℝ} \{ λ {x}^{2} - 2 γ x \vert 0 \leq γ x , \vert x \vert \leq ξ \} = \{ \begin{matrix}sgn ( γ ) min \{ ξ , \frac{\vert γ \vert}{λ} \} & ( λ > 0 ) \\ sgn ( γ ) \cdot ξ & ( λ \leq 0 )\end{matrix} & ( 16 )\end{matrix}$$

Here, the functions proj and sgn are defined as the following Equations 17 and 18.

$$\begin{matrix}[ Equation 17 ] & \\ {[ proj ( x ) ]}_{i} = \{ \begin{matrix}- 1 & ( {x}_{i} \leq - 1 ) \\ {x}_{i} & ( - 1 < {x}_{i} < 1 ) \\ 1 & ( 1 \leq {x}_{i} )\end{matrix} & ( 17 )\end{matrix}$$

The vector γ and the vector d are γ=Js+h and d=s′−s, respectively. Here, it is determined that s′ is an N-dimensional vector at this stage. The difference between H(s′) and H(s) is expressed by the following Equation 19.

$$\begin{matrix}[ Equation 19 ] & \\ H ( {s}^{′} ) - H ( s ) = - \frac{1}{2} {d}^{⊤} Jd - {γ}^{⊤} d & ( 19 )\end{matrix}$$

The following Inequality 20 is established for the right side of Equation 19.

$$\begin{matrix}[ Inequality 20 ] & \\ - \frac{1}{2} {d}^{⊤} Jd - {γ}^{⊤} d \leq \frac{1}{2} {\sum }_{i = 1}^{N} ( λ {d}_{i}^{2} - 2 {γ}_{i} {d}_{i} ) & ( 20 )\end{matrix}$$

Here, s′ is defined as the following Equation 21.

$$\begin{matrix}[ Equation 21 ] & \\ {s}^{′} := \{ \begin{matrix}proj ( s + \frac{γ}{λ} ) & ( λ > 0 ) \\ sgn ( γ ) & ( λ \leq 0 )\end{matrix} & ( 21 )\end{matrix}$$

Then, from the definition, the vector d can be expressed as the following Equation 22.

$$\begin{matrix}[ Equation 22 ] & \\ {d}_{i} = \{ \begin{matrix}sgn ( {γ}_{i} ) min \{ \vert sgn ( {γ}_{i} ) - {s}_{i} \vert , \frac{\vert {γ}_{i} \vert}{λ} & ( λ > 0 ) \\ sgn ( {γ}_{i} ) - {s}_{i} & ( λ \leq 0 )\end{matrix} & ( 22 )\end{matrix}$$

All the elements of vector s are −1 or more and +1 or less. Therefore, γᵢdᵢ≥0 and |dᵢ|≤|sgn(γᵢ)−sᵢ| are established for i=1, . . . , N. Then, from Equation 16, the vector d of Equation 22 minimizes the right side of Equation 20, and its value is 0 or less. From the above, the right side of Equation 19 is 0 or less, and H(s′)≤H(s) is established. That is, s′ always becomes energy less than or equal to s.

By the way, the vector s′ is given by Equation 21. Therefore, each component of s′ is always −1 or more, and +1 or less. That is, s′ can also be the answer to the minimization problem of Equation 5.

As described above, the vector γ is γ=Js+h. Therefore, Equation 21 can be rewritten as follows.

$$\begin{matrix}[ Equation 23 ] & \\ {s}^{′} := \{ \begin{matrix}proj ( s + \frac{Js + h}{λ} ) & ( λ > 0 ) \\ sgn ( Js + h ) & ( λ \leq 0 )\end{matrix} & ( 23 )\end{matrix}$$

Therefore, when the vector s′ is calculated based on Equation 23 for the solution s obtained as an approximate solution of Equation 5, this is a solution equal to or better than s. Since the calculation of Equation 23 can be calculated independently for each element, parallel calculation is possible.

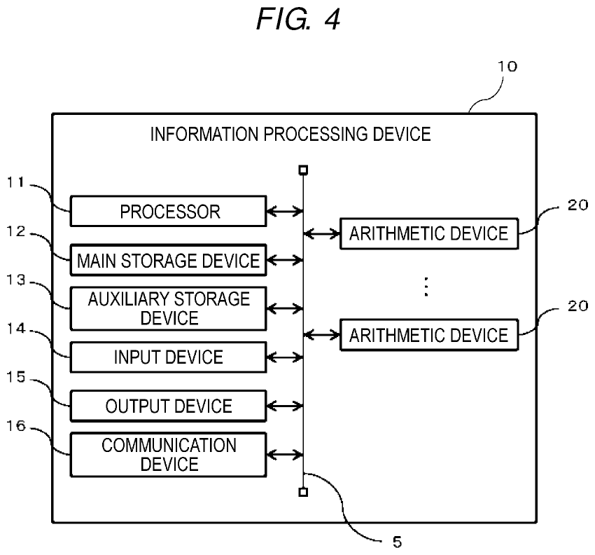

Based on the above, FIGS. 4 to 6 show the configuration of the information processing device that realizes the present invention.

FIG. 4 is an example of an information processing device that searches for the optimum solution of a mixed binary quadratic programming problem. As shown in the drawing, the information processing device 10 includes a processor 11, a main storage device 12, an auxiliary storage device 13, an input device 14, an output device 15, a communication device 16, one or more arithmetic devices 20, and a system bus 5 for communicably connecting the above devices. The information processing device 10 may be realized by using a virtual information processing resource such as a cloud server in which a part or all thereof is provided by a cloud system, for example. Further, the information processing device 10 may be realized by, for example, a plurality of information processing devices that are communicably connected and operate in cooperation with each other.

The processor 11 is configured by using, for example, a central processing unit (CPU) or a micro processing unit (MPU). The main storage device 12 is a device that stores programs and data, and is, for example, a read only memory (ROM), a static random access memory (SRAM), a non-volatile RAM (NVRAM), a mask read only memory (mask ROM), and a programmable ROM (PROM), and the like), a random access memory (RAM) (dynamic random access memory (DRAM), and the like), and the like. The auxiliary storage device 13 is a hard disk drive, a flash memory, a solid state drive (SSD), an optical storage device (compact disc (CD), digital versatile disc (DVD), and the like) and the like. The programs and data stored in the auxiliary storage device 13 are read into the main storage device 12 at any time.

The input device 14 is a user interface that receives input of information from the user, and is, for example, a keyboard, a mouse, a card reader, a touch panel, or the like. The output device 15 is a user interface that provides information to the user, and is, for example, a display device (liquid crystal display (LCD), graphic card, and the like) that visualizes various information, an audio output device (speaker), a printing device, and the like. The communication device 16 is a communication interface that communicates with other devices, and is, for example, a network interface card (NIC), a wireless communication module, a universal serial interface (USB) module, a serial communication module, and the like.

The arithmetic device 20 is a device that executes processing related to the search for the optimum solution of the mixed binary quadratic programming problem. The arithmetic device 20 may take the form of an expansion card to be mounted on the information processing device 10, such as a graphics processing unit (GPU). The arithmetic device 20 is composed of hardware such as a complementary metal oxide semiconductor (CMOS) circuit, a field programmable gate array (FPGA), and an application specific integrated circuit (ASIC). The arithmetic device 20 includes a control device, a storage device, an interface for connecting to the system bus 5, and transmits and receives commands and information to and from the processor 11 via the system bus 5. The arithmetic device 20 may be communicably connected to another arithmetic device 20 via a communication line to operate in cooperation with the other arithmetic device 20, for example. The function realized by the arithmetic device 20 may be realized, for example, by causing a processor (CPU, GPU, etc.) to execute a program.

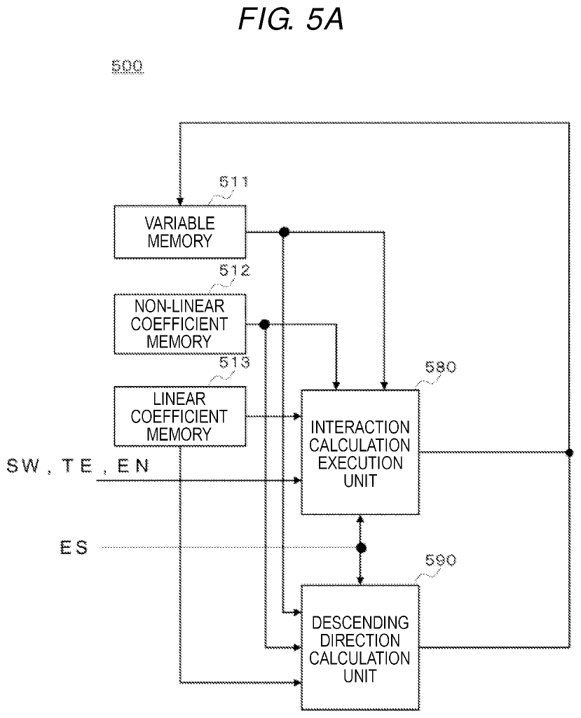

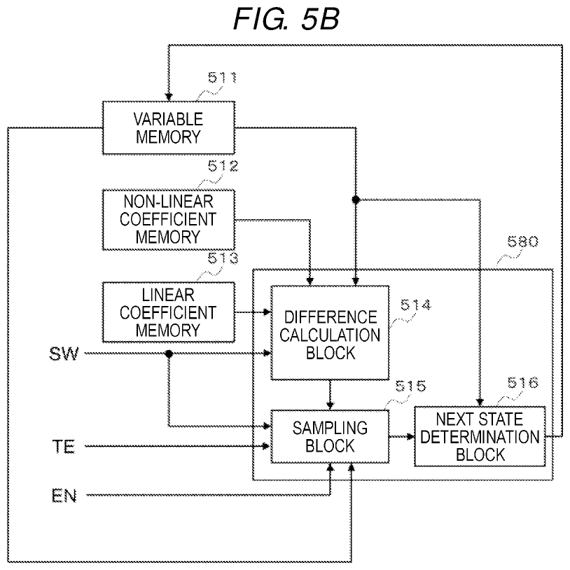

The arithmetic device 20 shown in FIG. 4 will be described later in FIGS. 5A and 5B. One or a plurality of arithmetic devices 20 can be mounted.

FIGS. 5A and 5B are diagrams for illustrating the operating principle of the arithmetic device 20 and are block diagrams of a circuit (hereinafter, referred to as an arithmetic circuit 500) constituting the arithmetic device 20. The arithmetic circuit 500 stochastically updates the value of the variable represented in the variable memory based on MCMC. For example, the arithmetic circuit 500 realizes a function of sampling the variable array x₁, . . . , x_{N} or the variable array y₁, . . . , y_{N} from the Boltzmann distribution (Equation 12) at the temperature T. Hereinafter, the operating principle of the arithmetic device 20 will be described with reference to the same drawings.

As shown in FIG. 5A, the arithmetic circuit 500 includes a variable memory 511, a non-linear coefficient memory 512, a linear coefficient memory 513, an interaction calculation execution unit 580, and a descending direction calculation unit 590.

Information indicating the variables x₁, . . . , x_{N} and y₁, . . . , y_{N} described above is stored in the variable memory 511 of each arithmetic circuit 500 (see FIG. 2).

Information representing the matrix J is stored in the non-linear coefficient memory 512. The matrix J is generally a symmetric matrix and this symmetry can be used to reduce the usage of the non-linear coefficient memory 512. Information representing the vector h is stored in the linear coefficient memory 513.

As shown in the same drawing, a signal SW, a control signal EN, and a temperature signal TE are input to the arithmetic circuit 500. Further, a control signal ES for selectively operating the interaction calculation execution unit 580 and the descending direction calculation unit 590 is input.

FIG. 5B is a diagram showing the internal configuration, and input and output of the interaction calculation execution unit 580. The interaction calculation execution unit 580 executes the interaction calculation in parallel in the complete bipartite graph and calculates the next state of the variable. An example of executing the interaction calculation is disclosed in, for example, WO2019/216277, which can be applied. In this embodiment, a configuration example for solving a mixed binary quadratic programming problem will be described.

In FIG. 5B, the signal EN is a signal that periodically repeats the values of H (high) and L (low) and represents which of the variable arrays x and y is updated. For example, when EN is H, the variable array x is updated, and when L, y is updated. By this signal EN, the variables x₁, . . . , x_{N} are updated at the same time, and the variables y₁, . . . , y_{N} are updated at the same time. In FIG. 5B, the signal EN is input only to the sampling block 515 for simplification, but the same is applied to other places, such as a variable memory, that require this signal.

The signal SW is a signal representing a vector of N elements representing the diagonal components of the diagonal matrix W. In the difference calculation block 514, the value of the matrix J stored in the non-linear coefficient memory 512, the vector h stored in the linear coefficient memory 513, the signal SW, and the variable s (x or y) stored in the variable memory 511 are input. The difference calculation block 514 outputs (J+diag (w₁, . . . , w_{N})) y+h when the signal EN is H, and outputs (J+diag (w₁, . . . , w_{N})) x+h when EN is L. This output value corresponds to the above-mentioned Aᵢ.

The sampling block 515 receives the output of the difference calculation block 514, the signal SW, the signal TW holding the value of the temperature parameter, the signal EN, and the values of other variables. Then, the i-th element is randomly sampled and output from the truncated normal distribution represented by Equation 12 having the domain of −(2−|yᵢ|) or more and (2−|yᵢ|) or less when the signal EN is H and the domain of −(2−|xᵢ|) or more and (2−|xᵢ|) or less when EN is L.

The next state determination block 516 determines the next state of the variable based on one or more values output from the sampling block 515. If the update rule of MCMC is defined as a simple heat-bath method, the next state determination block 516 may receive only one output value of the sampling block 515 and write the received output value as it is to the variable memory 511. Further, if a known over-relaxation method is used as the update rule of MCMC, the next state determination block 516 receives a plurality of values from the sampling block 515 and the current value of the variable to be updated from the variable memory 511, and selects one according to the over-relaxation method and write the selected one to the variable memory 511. As is well known, in the over-relaxation method, the next state is determined so that the correlation with the immediately preceding state is negative.

In FIG. 5A, the descending direction calculation unit 590 calculates the transition destination s′ that the objective function based on the equation 23 does not increase, which was clarified earlier. In Equation 23, in addition to the current state s, the maximum eigenvalues λ of Js+h and −J, which are the answers to the matrix·vector product, are required. The vector s is obtained by reading from the variable memory 511. Further, J is read from the non-linear coefficient memory 512, and h is read from the linear coefficient memory 513. The solution of Js+h is obtained by executing the matrix·vector product in the descending direction calculation unit 590. Also, the maximum eigenvalue λ can be efficiently calculated by a commonly known algorithm called the power method (with origin shift). This is to repeatedly execute the matrix·vector product, and the place where the above-mentioned matrix·vector product is executed can be utilized.

In FIG. 5A, the relationship between the operations of the interaction calculation execution unit 580 and the descending direction calculation unit 590 operates, for example, such that those operations alternately perform the calculation and that (1) the interaction calculation execution unit 580 calculates s and stores the s in the variable memory 511, (2) the descending direction calculation unit 590 calculates s′ and stores the s′ in the variable memory 511, and (3) the operation is returned to (1) (repeated subsequently). Even if s is not a local solution, s′ moves to a transition destination where the objective function does not increase.

(1) and (2) do not have to be switched alternately once and, for example, the operation may be made so that (1) is executed n times consecutively, (2) is executed m times, and then the operation returns to (1).

In addition to repeating (1) and (2) periodically, there is also a method that (2) is not performed much and the frequency of (1) is increased at the start of annealing, and the frequency of (2) is increased as the annealing progresses. Alternatively, various patterns can be considered, such as executing only (1) all the time and executing (2) only once at the end of annealing.

The calculation of the descending direction calculation unit 590 is to “move the variable in the direction in which the energy always decreases”, which corresponds to MCMC at a temperature of 0 in the context of annealing. In annealing, it is necessary to gradually cool the temperature from high temperature to low temperature, so the calculation operation by gradually lowering the temperature of the interaction calculation execution unit 580 is necessary, and in the meantime, the calculation of the descending direction calculation unit 590 is performed.

The calculation frequency and timing of s′ by the descending direction calculation unit 590 can be arbitrarily controlled by the control signal ES as described above according to the type and scale of the problem to be solved, or the demand for calculation speed and accuracy. Normally, the frequency of the number of calculations by the descending direction calculation unit 590 may be less than the number of calculations of the interaction calculation execution unit 580.

The output of the interaction calculation execution unit 580 and the descending direction calculation unit 590 is the next state of the variable that is stochastically updated by MCMC. This is written to the variable memory 511. Note that the control signal ES executes only either the interaction calculation execution unit 580 or the descending direction calculation unit 590. Therefore, even when writing to the variable memory 511, the output value of the interaction calculation execution unit 580 or the descending direction calculation unit 590 is selected based on the control signal ES.

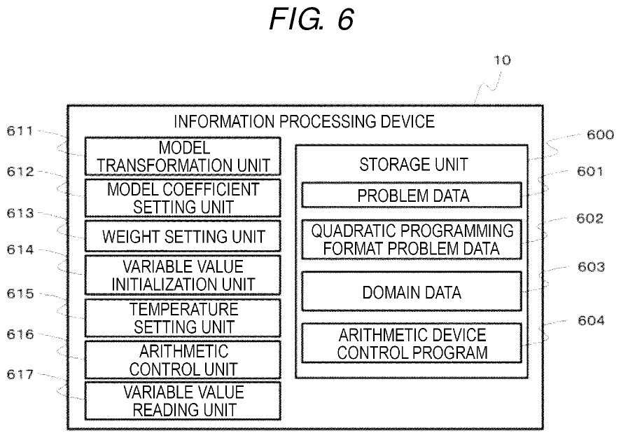

FIG. 6 shows the main functions (software configuration) of the information processing device 10. As shown in the drawing, the information processing device 10 includes a storage unit 600, a model transformation unit 611, a model coefficient setting unit 612, a weight setting unit 613, a variable value initialization unit 614, a temperature setting unit 615, an arithmetic control unit 616, and a variable value reading unit 617. These functions are realized by the processor 11 reading and executing the program stored in the main storage device 12, or by the hardware included in the arithmetic device 20. The information processing device 10 may have other functions such as an operating system, a file system, a device driver, and a data base management system (DBMS) in addition to the above functions.

Among the above functions, the storage unit 600 stores problem data 601, quadratic programming format problem data 602, domain data 603, and an arithmetic device control program 604 in the main storage device 12 or the auxiliary storage device 13. The problem data 601 is, for example, data in which an optimization problem or the like is described in a known predetermined description format. The problem data 601 is set by the user, for example, via a user interface (input device, output device, communication device, or the like).

The quadratic programming format problem data 602 is data generated by the model transformation unit 611 transforming the problem data 601 into data in a format that matches the format of the quadratic programming problem represented by Equation 4. In this transformation, the domain of each given variable is written in the domain data 603. The domain data indicates, for example, whether each variable takes a binary value or a real value. The arithmetic device control program 604 is a program that is executed when the arithmetic control unit 616 controls the arithmetic device 20, or is loaded by the arithmetic control unit 616 into each arithmetic device 20 and executed by the arithmetic device 20.

The model transformation unit 611 transforms the problem data 601 into the quadratic programming format problem data 602, which is the format of the quadratic programming problem. For this purpose, the function of deriving Equation 11 from Equation 1 may be implemented in the model transformation unit 611 as software or hardware. The function of the model transformation unit 611 does not necessarily have to be implemented in the information processing device 10, and may be such that the information processing device 10 takes in the quadratic programming format problem data 602 generated by another information processing device or the like via the input device 14 or the communication device 16.

The model coefficient setting unit 612 sets the matrix J of Equation 4 in the non-linear coefficient memory 512 and the vector h in the linear coefficient memory 513 based on the quadratic programming format problem data 602.

The variable value initialization unit 614 initializes the value of each variable stored in the variable memory 511 of the arithmetic device 20. The variable value initialization unit 614 only needs to determine, for example, by randomly sampling the value of each variable uniformly from −1 or more and +1 or less. At this time, care must be taken to satisfy the constraints on variables. One of the constraints is |xᵢ|+|yᵢ|≤2. Also, other constraints can be considered.

The temperature setting unit 615 sets the temperature T used when the arithmetic control unit 616 searches for the optimum solution.

The arithmetic control unit 616 causes the arithmetic device 20 to execute the calculation (hereinafter, referred to as an interaction calculation) for searching the variable arrays x and y that minimize the function G represented by Equation 11 for each temperature T set by the temperature setting unit 615. In the interaction calculation, the arithmetic control unit 616 changes, for example, the temperature T from the higher side to the lower side.

The variable value reading unit 617 reads the variable arrays x and y stored in the variable memory 511 when the optimum solution search by the arithmetic control unit 616 is completed. The value read here is the solution of Equation 11. According to the above argument, the N-dimensional vector s*=(x+y)/2 is calculated. Then, the domain data 603 is read out and the vector s⁺ obtained by Equation 6 is output to the output device 15 and the communication device 16 as the final solution. That is, it means that if the i-th domain is found to be {−1, +1} in the domain data 603, sgn (s*ᵢ) is output, and if the i-th domain is [−1, +1], sᵢ itself is output. In this way, a solution according to the defined range is obtained.

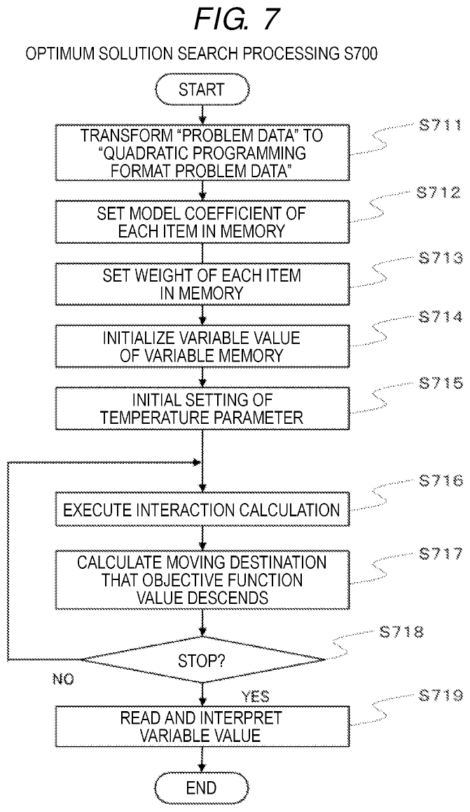

FIG. 7 is a flowchart illustrating the processing (hereinafter, referred to as optimum solution search processing S700) performed by the information processing device 10 when searching for the optimum solution. Hereinafter, the optimum solution search processing S700 will be described with reference to the same drawing. In the following, the letter “S” attached before the reference numeral means a processing step. The optimum solution search processing S700 is started by receiving an instruction from the user or the like via the input device 14, for example.

As shown in the figure, the model transformation unit 611 first transforms the problem data 601 into the quadratic programming format problem. data 602 (S711). In the quadratic programming format problem data, for example, the matrix J and the vector h in the function H expressed by Equation 1 are expressed in an arbitrary format. If the storage unit 600 has already stored the quadratic programming format problem data 602, the process S711 is omitted. The process of S711 and S712 and the subsequent processes may be executed by different devices. Further, the process of S711 and S712 and the subsequent processes may be executed at different timings (for example, it is conceivable that the process of S711 is performed in advance).

Subsequently, the model coefficient setting unit 612 sets the values of the matrix J and the vector h in the non-linear coefficient memory 512 and the linear coefficient memory 513 (S712). The memory value can also be set or edited by the user via a user interface (for example, realized by the input device 14, the output device 15, the communication device 16, and the like).

Subsequently, the weight setting unit 613 determines the value of the signal SW. As described in Equation 8 above, the signal SW is allowed to take an arbitrary value in searching for the optimum solution. Therefore, the signal value may always be 0. In this case, the calculation load can be reduced. Further, the value may be determined from the eigenvalues of the matrix J as shown in Equations 3 to 5 of WO2019/216277. Alternatively, the value may be determined from the sum of rows of the matrix J. The calculation of the value calculation of the signal SW may be executed in the arithmetic device 20 or in the processor 11. Alternatively, the user may set the value by himself/herself (S713).

Subsequently, the variable value initialization unit 614 initializes the value of each variable stored in the variable memory 511 (S714). The value stored in the variable memory 511 is a continuous value. As mentioned earlier, the initial value may be random. With the above, the parameter expressing Equation 11 is set.

Subsequently, the temperature setting unit 615 sets the series Tₖ (k=1, 2, 3, . . . ) of the temperature parameters used in the optimum solution search (S715). The above-mentioned subscript k represents the type of temperature T to be set. As a method for setting the temperature T, for example, the method of JP-A-2016-51314 can be adopted.

Subsequently, the arithmetic control unit 616 executes the stochastic simultaneous update of the variable array by the arithmetic of the arithmetic circuit 500 shown in FIG. 5A (S716 to S717). Which of S716 and S717 is to be executed is selected, for example, by the control signal EN.

Subsequently, the arithmetic control unit 616 determines whether or not the stop condition is satisfied (for example, whether or not the temperature T has reached a preset minimum temperature) (S718). When the arithmetic control unit 616 determines that the stop condition is satisfied (S718: YES), the process proceeds to S719. On the other hand, when the arithmetic control unit 616 determines that the stop condition is not satisfied (S718: NO), the process returns to S716.

In S719, the variable value reading unit 617 reads the value of the variable stored in the variable memory 511 and the domain of each variable of the quadratic programming format problem data 602 stored in the domain data 603. Then, the vector through the transformation based on Equation 6 is calculated and output as the solution of Equation 2 or Equation 4. This completes the optimum solution search processing S700.

As described in detail above, according to the information processing device 10 of the present embodiment, the optimum solution search for the mixed binary quadratic programming problem can be efficiently performed. Therefore, the optimization problem can be solved efficiently. Since the information processing device 10 (including the arithmetic device 20) has a simple structure, which makes it possible to be manufactured inexpensively and easily.

The arithmetic circuit 500 maybe configured by software or hardware as long as it has a function of executing a calculation for solving the optimization problem described above. Specifically, in the annealing method, not only the hardware mounted by an electronic circuit (digital circuit or the like) but also the method of mounting by a superconducting circuit or the like may be used. Further, hardware that realizes the Ising model other than the annealing method may be used. For example, a laser network method (optical parametric oscillation), a quantum neural network, and the like are known. Further, although some ideas are different, a quantum gate method in which the calculation performed by the Ising model is replaced with gates such as a Hadamard gate, a rotation gate, and a control NOT gate can also be adopted as the configuration of this embodiment.

As a specific implementation example of the arithmetic circuit 500, an example of mounting as a complementary metal-oxide semiconductor (CMOS) integrated circuit described in JP-A-2016-51314 or a logic circuit on a field programmable gate array (FPGA) will be described.

In the technique of JP-A-2016-51314, a large number of units to which the technology of static random access memory (SRAM) is applied are arranged, and a memory for storing variables and a circuit for updating variables are arranged in each unit.

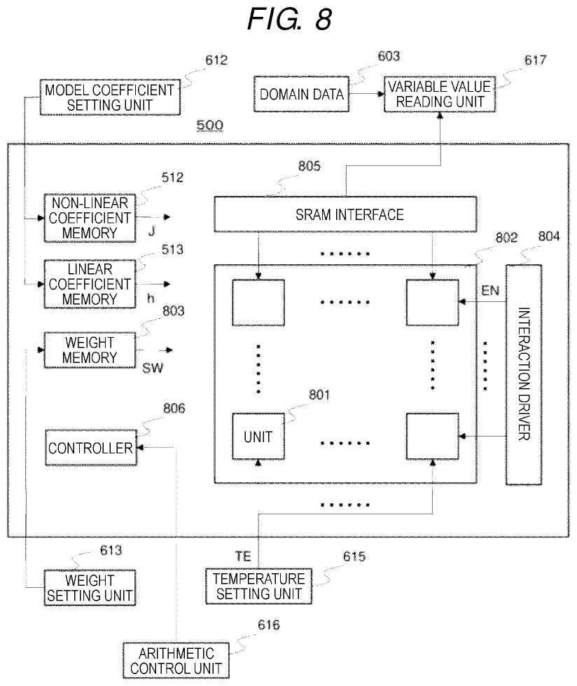

FIG. 8 is a block diagram showing a circuit configuration example when the SRAM technology is applied to the arithmetic circuit 500 of this embodiment. A plurality of units 801 constitute an array unit 802. Such a configuration can be manufactured by applying the semiconductor manufacturing technology.

One unit 801 includes a multi-value memory 901 that stores any one of the variables x₁, . . . , x_{N} and y₁, . . . , y_{N}, and a configuration for updating the value of the multi-value memory 901. That is, 2N units 801 are prepared.

The configuration example of FIG. 8 will be described with reference to the generalized configuration of FIGS. 5A and 5B. The data stored in the non-linear coefficient memory 512 and the linear coefficient memory 513 is set by the model coefficient setting unit 612. The non-linear coefficient memory 512 stores an N×N matrix J, which is commonly used by all the units 801. Further, the linear coefficient memory 513 stores the N-dimensional vector h, which is commonly used by all the units 801. In order to reduce the circuit scale, these memories are common to each unit 801. Therefore, the non-linear coefficient memory 512 and the linear coefficient memory 513 supply the coefficients J and h to all the units 801 but the signal lines for that purpose are omitted in FIG. 8. In principle, each unit 801 may individually include the non-linear coefficient memory 512 and the linear coefficient memory 513.

The weight memory 803 stores N element vectors (w₁, . . . , w_{N}) representing the diagonal components of the diagonal matrix W. This data is set by the weight setting unit 613. Since the i-th unit that stores xᵢ and yᵢ uses the i-th component wᵢ, it is necessary to switch the value of the signal SW for each unit 801. In FIG. 8, the signal line for supplying the signal SW to the unit 801 is omitted.

The temperature signal TE supplied from the temperature setting unit 615 is supplied to all units 801. The function and configuration of the temperature signal follow the related art . The signal line that supplies the signal TE to the unit 801 is omitted.

An interaction driver 804 alternately inputs a signal for allowing the update of the variable x and a signal for allowing the update of the variable y to each unit 801. As a result, the variables x₁ to x_{N} are updated at the same time, and the variables y₁ to y_{N} are updated at the same time.

The SRAM interface 805 writes and reads with respect to the memory that stores the variables of the unit 801 created by applying the circuit configuration of the SRAM. The variable read after the processing in the arithmetic circuit 500 is completed is sent to the variable value reading unit 617. The variable value reading unit 617 obtains a solution to the mixed binary quadratic programming problem by outputting the read variable as a continuous value or a binary value based on the domain data 603.

The controller 806 initializes the arithmetic circuit 500 and reports the end of processing according to the instruction of the arithmetic control unit 616.

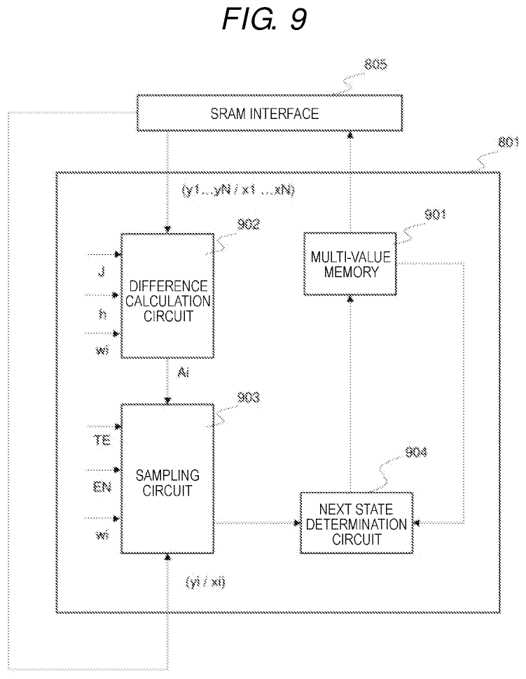

FIG. 9 is a diagram showing a circuit configuration example of one unit 801. One unit includes a multi-value memory 901 that stores any one of the continuous variables x₁, . . . , x_{N} and y₁, . . . , y_{N}.

A difference calculation circuit 902 realizes the function of the difference calculation block 514. When the variable stored in the multi-value memory 901 is any one of x₁, . . . , x_{N}, the vector of (y₁, . . . , y_{N}) is input to the difference calculation circuit 902. When the variable stored in the multi-value memory 901 is any one of y₁, . . . , y_{N}, the vector of (x₁, . . . , x_{N}) is input. These variable vectors are read and generated by the SRAM interface 805 from the multi-value memory 901 of another unit 801. Further, the N×N matrix J and the N-dimensional vector h, which are coefficients, are input. In addition, the weight wᵢ is input. The difference calculation circuit 902 outputs the value Aᵢ of the i-th row of (J+diag w₁, . . . , w_{N})) s+h (s is a variable vector of x or y) for these inputs.

A sampling circuit 903 realizes the function of the sampling block 515. The output Aᵢ, the signal EN, the signal SW, the signal TE, and yᵢ when the variable stored in the multi-value memory 901 is xᵢ, and xᵢ when the variable stored in the multi-value memory 901 is yᵢ are input to the sampling circuit 903. Then, the candidate of the next state of the variable is sampled from the existence probability p(sᵢ) of the variable sᵢ based on Equation 12.

A state determination circuit 904 determines the next state of the variable based on one or a plurality of candidates output from the sampling circuit 903. In the state determination circuit 904, for example, in the case of following the over-relaxation method, when a plurality of candidates are obtained from the sampling circuit 903, the candidate whose correlation with the state of the multi-value memory 901 immediately before is negative is selected to determine the next state. The determined next state is stored in the multi-value memory 901.

In the above, the difference calculation block 514, the sampling block 515, and the next state determination block 516 are assumed to be hardware such as FPGA, but for example, software implementation utilizing a large number of arithmetic devices mounted on a GPU or a vector type computer is also possible. By providing a large number of units 801 in this way, it is possible to update variables in parallel.

Although one embodiment has been described in detail above, it is needless to say that the present invention is not limited to the above-described embodiment and various modifications can be made without departing from the gist thereof. For example, the above-described embodiment has been described in detail in order to explain the present invention in an easy-to-understand manner and is not necessarily limited to the one including all the described configurations. Further, the addition, deletion, and replacement of a part of the configuration of the above embodiment with another configuration is also possible.

Further, a part or all of the above configurations, functional units, processing units, processing means, and the like may be designed in, for example, an integrated circuit and may be realized by hardware. Further, each of the above configurations, functions, and the like may be realized by software by the processor interpreting and executing a program that realizes each function. Information such as programs, tables, and files that realize each function can be placed in a recording device such as a memory, a hard disk, a solid state drive (SSD), or a recording medium such as an IC card, an SD card, or a DVD.

Also, in each of the above drawings, the control lines and information lines are shown as necessary for explanation, and not all the control lines and information lines in the implementation are necessarily shown. For example, in practice, almost all configurations may be considered interconnected.

Further, the arrangement form of various functional units, various processing units, and various databases of the information processing device 10 described above is only an example. The arrangement form of the various functional units, the various processing units, and the various databases can be changed to the optimal arrangement form from the viewpoints of the performance, processing efficiency, communication efficiency, and the like of the hardware and software included in the information processing device 10.

In addition, the configuration of the database (schema, and the like) that stores the various data described above can be flexibly changed from the viewpoints of efficient use of resources, improvement of processing efficiency, improvement of access efficiency, improvement of search efficiency, and the like.

The present invention can be used for information processing devices, arithmetic devices, information processing methods, and the like.

What is claimed is:

1. An information processing system comprising:
a variable memory that stores variables;
a state transition calculation block that calculates the next state of the variable;
a non-linear coefficient memory that stores a non-linear coefficient of the state transition calculation block;
a linear coefficient memory that stores a linear coefficient of the state transition calculation block; and
a temperature input line that receives a temperature signal of the state transition calculation block, wherein
the state transition calculation block includes
an interaction calculation execution unit that calculates the next state of the variable based on the variable, the non-linear coefficient, the linear coefficient, and the temperature signal,
a descending direction calculation unit that calculates the next state of the variable based on the variable, the non-linear coefficient, and the linear coefficient, and
a control signal line that receives a control signal that selects operations of the interaction calculation execution unit and the descending direction calculation unit.

2. The information processing system according to claim 1, wherein
the interaction calculation execution unit expresses an interaction model as a complete bipartite graph between the variables and updates the variables s in parallel, and
the descending direction calculation unit calculates s′ where an objective function H of the interaction model is H(s′)≤H(s) based on the variables s.

3. The information processing system according to claim 2, wherein
when the s is an N-dimensional vector,
the non-linear coefficient J is an N×N matrix,
the linear coefficient h is an N-dimensional vector, and
λ is the maximum eigenvalue of −J,
$$\begin{matrix}[ Equation 24 ] \\ {s}^{′} := \{ \begin{matrix}proj ( s + \frac{Js + h}{λ} ) & ( λ > 0 ) \\ sgn ( Js + h ) & ( λ \leq 0 )\end{matrix} \\ {[ proj ( x ) ]}_{i} = \{ \begin{matrix}- 1 & ( {x}_{i} \leq - 1 ) \\ {x}_{i} & ( - 1 < {x}_{i} < 1 ) \\ 1 & ( 1 \leq {x}_{i} )\end{matrix} \\ {[ sgn ( x ) ]}_{i} = \{ \begin{matrix}- 1 & ( {x}_{i} \leq 0 ) \\ 1 & ( 1 \leq {x}_{i} )\end{matrix} .\end{matrix}$$

4. The information processing system according to claim 3, wherein
the objective function H is
$$[ Equation 25 ] \\ H ( s ) = - \frac{1}{2} {s}^{⊤} Js - {h}^{⊤} s . \qquad$$

5. The information processing system according to claim 4, further comprising:
a weight input line that receives a weight signal of the state transition calculation block, wherein
the interaction calculation execution unit includes
a difference calculation block that calculates a difference using the weight signal, the non-linear coefficient, and the linear coefficient,
a sampling block that randomly samples from a probability distribution with interval constraints using the weight signal, the temperature signal, and an output value of the difference calculation block, and
a next state determination block that calculates the next state of the variable using a value read from the variable memory.

6. The information processing system according to claim 5, wherein
the variable memory stores continuous values as values x₁, . . . , x_{N} and y₁, . . . , y_{N} indicating the state of the variable .

7. The information processing system according to claim 6, wherein
the weight signal SW is a signal representing a vector of N elements representing diagonal components w₁, . . . , w_{N} of a diagonal matrix W.

8. The information processing system according to claim 7, wherein
the non-linear coefficient J, the linear coefficient h, the weight signal SW, and the values stored in the variable memory are input to the difference calculation block and (J+diag (w₁, . . . , w_{N})) s+h is output,
where s is one of the N-dimensional vectors (x₁, . . . , x_{N}) and (y₁, . . . , y_{N}).

9. The information processing system according to claim 8, wherein
an output A of the difference calculation block, the weight signal SW, the temperature signal TE, a control signal EN, and the values stored in the variable memory are input to the sampling block,
one or a plurality of values are randomly sampled and output from a normal distribution whose domain is a first predetermined range when the control signal EN is a first value and whose domain is a second predetermined range when the control signal EN is a second value, and
the normal distribution is formed based on the output A, the weight signal SW, and the temperature signal TE.

10. The information processing system according to claim 9, wherein
the normal distribution is a normal distribution with mean Aᵢ/wᵢ and variance T/wᵢ,
where Aᵢ is the i-th value of the output A and T is the value of the temperature signal TE.

11. The information processing system according to claim 8, wherein
a plurality of units including a multi-value memory that stores one of the values x₁, . . . , x_{N} and y₁, . . . , y_{N} indicating the state of the variable are provided,
each of the units includes a difference calculation unit that executes apart of functions of the difference calculation block, a sampling unit that executes a part of functions of the sampling block, and a next state determination unit that executes a part of functions of the next state determination block,
in a unit including a multi-value memory that stores one of the values xᵢ or yᵢ indicating the state of the variable,
the difference calculation unit receives inputs of the non-linear coefficient J, the linear coefficient h, the i-th diagonal component wᵢ of the diagonal matrix W, and the N-dimensional vector (y₁, . . . , y_{N}) when the value stored in the multi-value memory of the unit is xᵢ, and the N-dimensional vector (x₁, . . . , x_{N}) when the value stored in the multi-value memory of the unit is yᵢ, and
outputs Aᵢ=hᵢ+wᵢsᵢ+Σᵢⱼsⱼ (where hᵢ indicates the i-th element of the linear coefficient h, and s indicates y when the value stored in the multi-value memory of the unit is xᵢ and indicates x when the value stored in the multi-value memory of the unit is yᵢ).

12. The information processing system according to claim 11, wherein
the output Aᵢ of the difference calculation unit, the diagonal component wᵢ, the temperature signal TE, a control signal EN, and the values stored in the variable memory are input to the sampling unit, and
one or a plurality of values are randomly sampled and output from a normal distribution that has mean Aᵢ/wᵢ and variance T/wᵢ, whose domain is a first predetermined range when the control signal EN is a first value and whose domain is a second predetermined range when the control signal EN is a second value,
(where T is the value of the temperature signal TE).
